(19) United States
(12) Patent Application Publication
(10) Pub. No.: US 2013/0155092 A1
(43) Pub. Date: Jun. 20, 2013

(54) ELECTRONIC DEVICE AND METHOD FOR SWITCHING BETWEEN FIRST DISPLAY AND SECOND DISPLAY

(71) Applicants: MENG-WEI CHUANG, Hsinchu (TW); LI-SHEN CHANG, Hsinchu (TW)

(72) Inventors: MENG-WEI CHUANG, Hsinchu (TW); LI-SHEN CHANG, Hsinchu (TW)

(21) Appl. No.: 13/663,575

(22) Filed: Oct. 30, 2012

(30) Foreign Application Priority Data
Dec. 20, 2011 (TW) 100147575

(51) Int. Cl. G09G 5/02; G06T 1/00; G09G 5/00

(52) U.S. Cl. 345/589; 345/4; 345/501

(57) ABSTRACT

An electronic device includes a first display for displaying static images, and a second display for displaying dynamic images. The first display includes a plurality of first pixels, and the second display includes a plurality of white pixels. The first display is stacked on the second display, and the plurality of first pixels respectively correspond to the plurality of white pixels.

### BACKGROUND

1. Technical Field

The disclosed embodiments relate to an electronic device and a method for switching between a first display and a second display.

2. Description of Related Art

Traditional electronic devices include a single display for displaying visual content. For example, a traditional device may include a liquid crystal display (LCD) or organic light-emitting diode (OLED) display for displaying color visual content. In another example, a traditional device may include an electronic paper display for displaying black-and-white visual content using minimal power. The type of display included in a traditional electronic device is typically based on an assumption about the visual content it will most often display because different types of displays may be optimal, in performance or efficiency, for different types of visual content. For example, an LCD or OLED display may be optimal for high-resolution or dynamic color content while an electronic paper display may be optimal for relatively static black-and-white content.

However, a traditional device may display multiple types of visual content even though its display may only be optimal for a single type of visual content.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout four views.

FIG. 1 is a block diagram of an electronic device in accordance with an embodiment, the electronic device includes a first display, a second display, and a processor.

FIG. 2A is an equivalent circuit diagram showing part of a pixel array in the first display and the second display shown in FIG. 1.

FIG. 2B is a circuit diagram showing the processor electrically connected to gate lines and data lines of the first display and the second display in FIG. 1.

FIG. 3 is flowchart showing a method for switching between a first display and a second display in accordance with a first embodiment.

### DETAILED DESCRIPTION

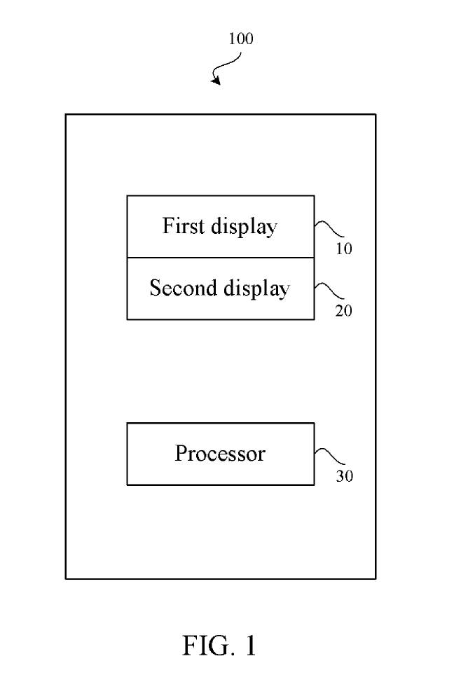

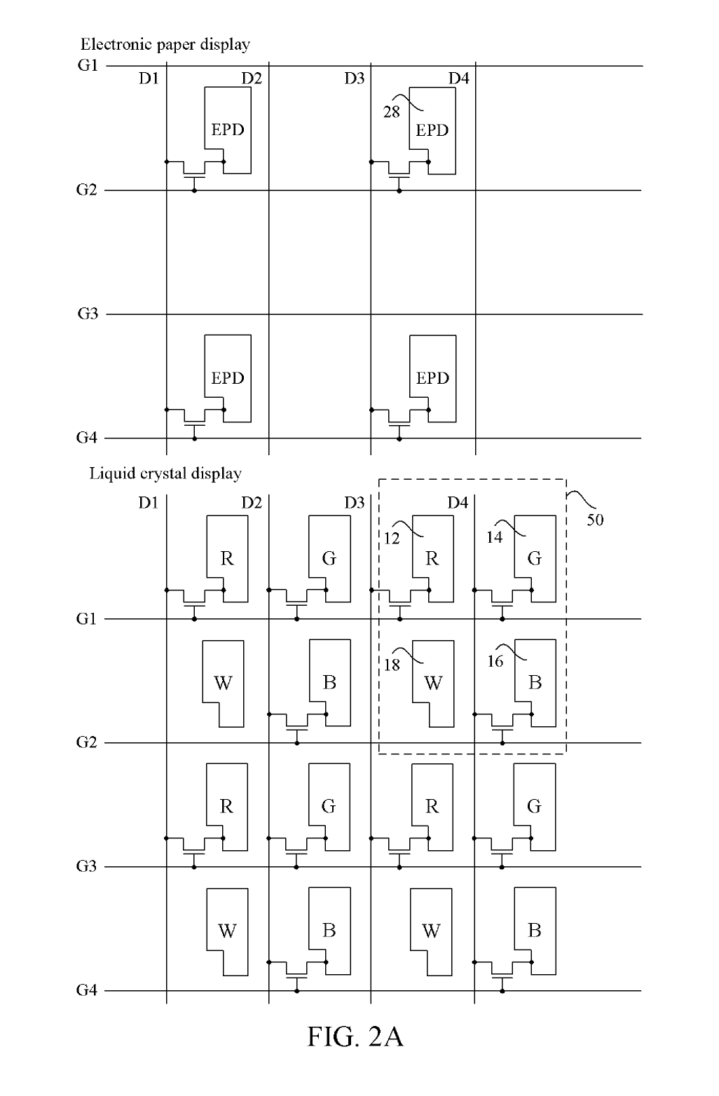

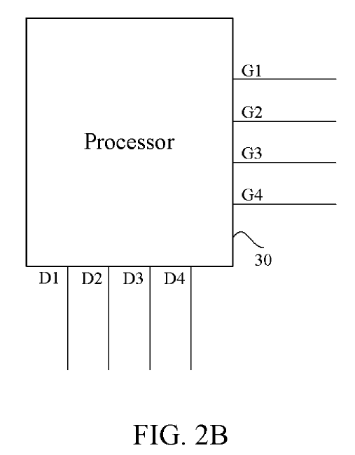

Referring to FIGS. 1 and 2A, an electronic device 100 includes a first display 10, a second display 20, and a processor 30. The first display 10 is used for displaying static images, the second display 20 is used for displaying dynamic images. The first display 10 is stacked on the second display 20. The first display 10 includes a plurality of first pixels 28, and the second display 20 includes a plurality of white (W) pixels 18, each of the white pixels 18 is translucent and does not emit light, the plurality of first pixels 28 respectively correspond to the plurality of white pixels 18.

The processor 30 determines at least one feature of the visual content, and selectively enables at least one of the first display 10 and the second display 20, based on the at least one determined feature, to display the visual content.

In a first embodiment, the visual content is an image file. The at least one feature of the image file includes a filename extension of the image file. The processor 30 enables the first display 10 to display the image files having one of a plurality of predetermined filename extensions; and enables the second display 20 to display all other image files having the filename extension different from one of the predetermined filename extensions. In this embodiment, the predetermined filename extensions are doc, docx, pdf, pdb, kwl, lit, poc, rte, azw.

In a second embodiment, the at least one feature of the visual content includes a rate of change of the visual content. The processor 30 enables the first display 10 to display the visual content if the rate of change is below a threshold; and enables the second display 20 to display the visual content if the rate of change is above the threshold.

In a third embodiment, the at least one feature of the visual content includes a color composition of the visual content. The processor 30 enables the first display 10 to display the visual content if the color composition is below a threshold; and enables the second display 20 to display the visual content if the color composition is above the threshold.

In this embodiment, the first display 10 is an electronic paper display, and the second display 20 is a liquid crystal display. That is, the first pixels 28 of the first display 10 are electronic paper display (EPD) pixels, the second display 20 further includes a plurality of red (R) pixels 12, a plurality of green (G) pixels 14, and a plurality of blue (B) pixels 16. Each EPD pixel 28 does not overlap one of the red pixels 12, each EPD pixel 28 does not overlap one of the green pixels 14, each EPD pixel 28 does not overlap one of the blue pixels 16. Furthermore, when the first display 10 displays the visual content, the backlight of the second display 20 is used as an external light source for illuminating the first display 10.

The EPD pixels of the first display 10 and the pixels of the second display 20 are arranged in one of a first form, a second form, a third form, a fourth form, a fifth form, and a sixth form respectively shown below in table 1, table 2, table 3, table 4, table 5 and table 6:

TABLE 1
the arrangement of the EPD pixels

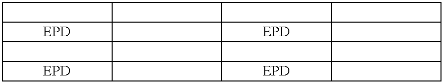

the arrangement of pixels of the second display

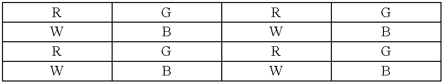

TABLE 2
the arrangement of the EPD pixels

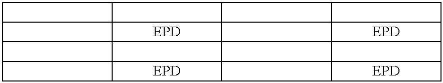

the arrangement of pixels of the second display

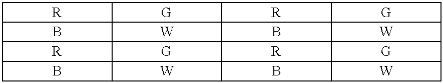

TABLE 3
the arrangement of the EPD pixels

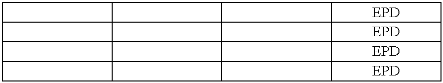

the arrangement of pixels of the second display

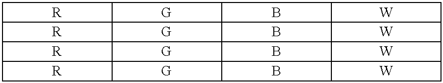

TABLE 4
the arrangement of the EPD pixels

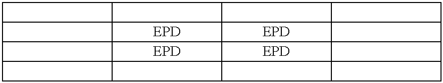

the arrangement of pixels of the second display

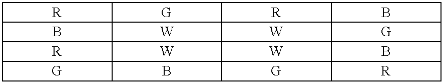

TABLE 5
the arrangement of the EPD pixels

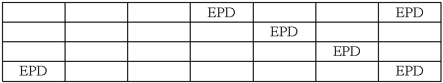

the arrangement of pixels of the second display

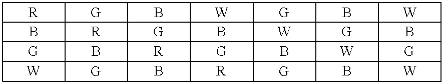

TABLE 6
the arrangement of the EPD pixels

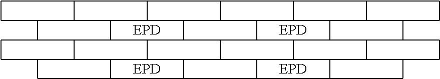

the arrangement of pixels of the second display

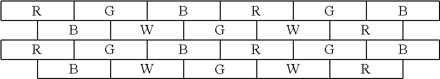

Further referring to FIG. 2B, using the above table 1 as an example. The first display 10 includes four EPD pixels 28 and four first thin film transistors (TFTs) 13 respectively correspond to four EPD pixels 28, the second display 20 includes four red (R) pixels 12, four green (G) pixels 14, four blue (B) pixels 16, four white (W) pixels 18, and twelve second TFTs 15 respectively correspond to four red pixels 12, four green pixels 14, four blue pixels 16. Because the first display 10 is stacked on the second display 20, four EPD pixels 28, four red pixels 12, four green pixels 14, and four blue pixels 16 form 4*4 pixel arrays.

The first display 10 further includes four data lines D1, D2, D3, D4 and four gate lines G1, G2, G3, G4. A gate of each first TFT 13 connects the corresponding gate line, a source of each first TFT 13 connects the corresponding data line, a drain of each first TFT 13 connects a pixel electrode of corresponding EPD pixel 28. The second display 20 further includes four data lines D1, D2, D3, D4 and four gate lines G1, G2, G3, G4. Four data lines D1, D2, D3, D4 and four gate lines G1, G2, G3, G4 are connected to the processor 30, and the processor 30 integrates a source driver and a gate driver (not shown). A gate of each second TFT 15 connects the corresponding gate line, a source of each second TFT 15 connects the corresponding data line, a drain of each second TFT 15 connects a pixel electrode of one of corresponding red pixel 12, green pixel 14, and blue pixel 16.

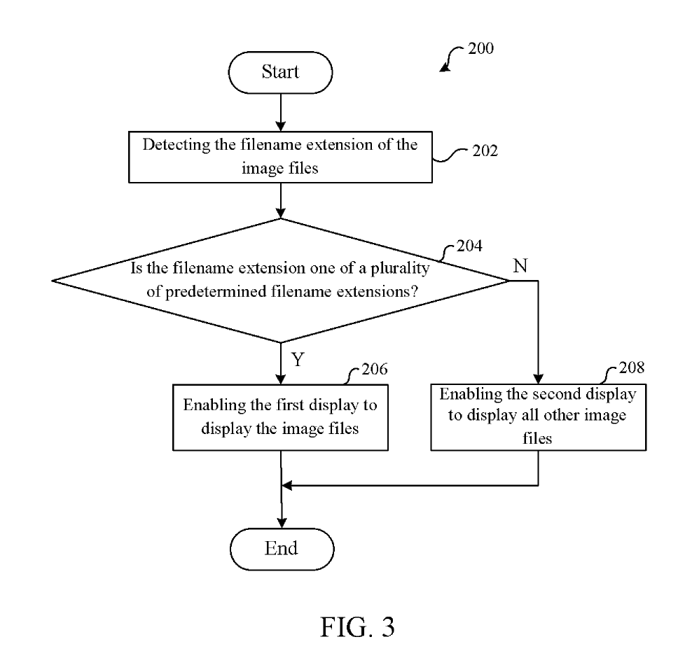

FIG. 3, illustrates a method 200 for switching between the first display 10 and the second display 20 in accordance with a first embodiment. The first display 10 is used for displaying static images, the second display 20 is used for displaying dynamic images. The first display 10 is stacked on the second display 20. The first display 10 includes a plurality of first pixels, and the second display 20 includes a plurality of second pixels, each of the first pixels and each of the second pixels are not overlapped with each other. The electronic device 100 implements the method 200, in this embodiment, the visual content is the image file, the first display 10 is an electronic paper display, the second display 20 is a liquid crystal display, and the first display 10 is stacked on the second display 20. The method 200 includes the following steps.

Step 202, the processor 30 detects the filename extension of the image files.

Step 204, the processor 30 determines whether the filename extension is one of doc, docx, pdf, pdb, kwl, lit, poc, rte, azw. If it is determined that the filename extension is one of doc, docx, pdf, pdb, kwl, lit, poc, rte, azw, the process goes to step 206. If it is determined that the filename extension is not one of doc, docx, pdf, pdb, kwl, lit, poc, rte, azw, the process goes to step 208.

Step 206, the processor 30 enables the first display 10 to display the image files having one of a plurality of predetermined filename extensions.

Step 208, the processor 30 enables the second display 20 to display all other image files having the filename extension different from one of the predetermined filename extensions. In this embodiment, the predetermined filename extensions are doc, docx, pdf, pdb, kwl, lit, poc, rte, azw.

In a second embodiment, the processor 30 detects a rate of change of the visual content, therefore the step 206 is replaced by the step of enabling the first display 10 to display the visual content if the rate of change is below a threshold. Step 208 is replaced by the step of enabling the second display 20 to display the visual content if the rate of change is above the threshold.

In a third embodiment, the processor 30 detects a color composition of the visual content, therefore step 206 is replaced by the step of enabling the first display 10 to display the visual content if the color composition is below a threshold. Step 208 is replaced by the step of enabling the second display 20 to display the visual content if the color composition is above the threshold.

Alternative embodiments will become apparent to those skilled in the art without departing from the spirit and scope of what is claimed. Accordingly, the present disclosure should not be deemed to be limited to the above detailed description, but rather only by the claims that follow and the equivalents thereof.

What is claimed is:

1. An electronic device, comprising:
a first display for displaying static images, the first display comprising a plurality of first pixels; and
a second display for displaying dynamic images, the second display comprising a plurality of white (W) pixels;
wherein the first display is stacked on the second display, and the plurality of first pixels respectively correspond to the plurality of white pixels.

2. The electronic device of claim 1, further comprising a processor, wherein the processor is operative to:
determine at least one feature of the visual content; and
selectively enable at least one of the first display and the second display, based on the at least one determined feature, to display the visual content.

3. The electronic device of claim 2, wherein the visual content is an image file, the at least one feature of the image file comprises a filename extension of the image file, and the processor is operative to:
enable the first display to display the image files having one of a plurality of predetermined filename extensions; and
enable the second display to display all other image files having the filename extension different from one of the predetermined filename extensions.

4. The electronic device of claim 3, wherein the predetermined filename extensions are doc, docx, pdf, pdb, kwl, lit, poc, rte, azw.

5. The electronic device of claim 2, wherein the at least one feature of the visual content comprises a rate of change of the visual content, and the processor is operative to:
enable the first display to display the visual content when the rate of change is below a threshold; and
enable the second display to display the visual content when the rate of change is above the threshold.

6. The electronic device of claim 2, wherein the at least one feature of the visual content comprises a color composition of the visual content, and the processor is operative to:
enable the first display to display the visual content when the color composition is below a threshold; and
enable the second display to display the visual content when the color composition is above the threshold.

7. The electronic device of claim 2, wherein the first display is an electronic paper display, the second display is a liquid crystal display, when the first display is enabled to display the visual content, the backlight of the second display is used as an external light source for illuminating the first display.

8. The electronic device of claim 1, wherein the first display is an electronic paper display, the second display is a liquid crystal display, and the first display is stacked on the second display.

9. The electronic device of claim 8, wherein the second display further comprises a plurality of red (R) pixels, a plurality of green (G) pixels, and a plurality of blue (B) pixels; the second pixel is an electronic paper display (EPD) pixel, each of the red pixels does not overlap the EPD pixel, each of the green pixels does not overlap the EPD pixel, and each of the blue pixels does not overlap the EPD pixel.

10. The electronic device of claim 9, wherein the EPD pixels and the pixels of the second display are arranged in one of a first form, a second form, a third form, a fourth form, a fifth form, and a sixth form respectively shown below in table 1, table 2, table 3, table 4, table 5 and table 6:
TABLE 1
the arrangement of the EPD pixels 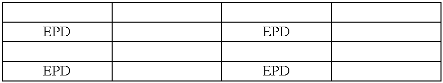
the arrangement of pixels of the second display 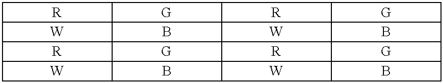
TABLE 2
the arrangement of the EPD pixels 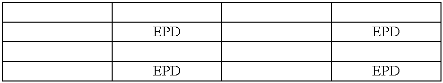
the arrangement of pixels of the second display 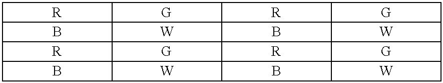
TABLE 3
the arrangement of the EPD pixels 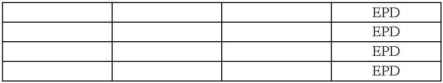
the arrangement of pixels of the second display 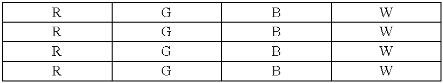
TABLE 4
the arrangement of the EPD pixels 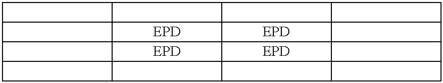
the arrangement of pixels of the second display 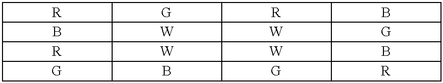
TABLE 5
the arrangement of the EPD pixels 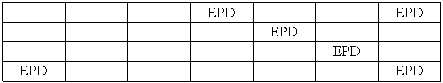
the arrangement of pixels of the second display 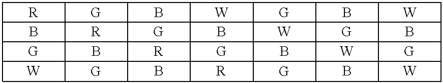
TABLE 6
the arrangement of the EPD pixels 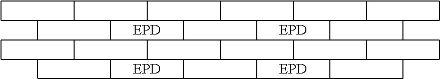
the arrangement of pixels of the second display

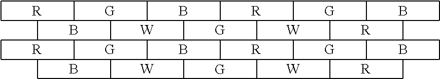

11. A method for switching between a first display and a second display, the first display used for displaying static images, the second display used for displaying dynamic images; the method comprising the steps of:
determining at least one feature of the visual content; and
selectively enabling at least one of the first display and the second display, based on the at least one determined feature, to display the visual content;
wherein the first display is stacked on the second display, the first display comprises a plurality of first pixels, the second display comprises a plurality of white pixels, the plurality of first pixels respectively correspond to the plurality of white pixels.

12. The method of claim 10, wherein the visual content is an image file, the at least one feature of the image file comprises a filename extension of the image file, the step of “selectively enabling at least one of the first display and the second display” comprises the sub-steps of:
enabling the first display to display the image files having one of a plurality of predetermined filename extensions; and
enabling the second display to display all other image files having the filename extension different from one of the predetermined filename extensions.

13. The method of claim 12, wherein the predetermined filename extensions are doc, docx, pdf, pdb, kwl, lit, poc, rte, azw.

14. The method of claim 11, wherein the at least one feature of the visual content comprises a rate of change of the visual content, the step of “selectively enabling at least one of the first display and the second display” comprises the sub-steps of:
enabling the first display to display the visual content when the rate of change is below a threshold; and
enabling the second display to display the visual content when the rate of change is above the threshold.

15. The method of claim 11, wherein the at least one feature of the visual content comprises a color composition of the visual content, the step of “selectively enabling at least one of the first display and the second display” comprises the sub-steps of:
enabling the first display to display the visual content when the color composition is below a threshold; and
enabling the second display to display the visual content when the color composition is above the threshold.

16. The method of claim 11, wherein the first display is an electronic paper display, the second display is a liquid crystal display, and the first display is stacked on the second display.

17. The method of claim 16, wherein when the first display is enabled to display the visual content, the backlight of the second display is used as an external light source for illuminating the first display.
